(19) United States
(12) Patent Application Publication
(10) Pub. No.: US 2010/0046249 A1
(43) Pub. Date: Feb. 25, 2010

(54) OPTIC FILM AND BACKLIGHT MODULE USING SAME

(76) Inventors: Chien-Chin Mai, Kaohsiung City (TW); Jui-Tang Yin, Kaohsiung City (TW); Yeong-Feng Wang, Kaohsiung City (TW)

Correspondence Address: LEONG C LEI, PMB # 1008, 1867 YGNACIO VALLEY ROAD, WALNUT CREEK, CA, 94598, US

(21) Appl. No.: 12/193,763

(22) Filed: Aug. 19, 2008

(51) Int. Cl. F21V 8/00; G02B 6/34

(52) U.S. Cl. 362/620; 385/36; 362/559

(57) ABSTRACT

An optic film includes a body and a condensation layer. The body is formed by stacking a plurality of substrates made of different materials. By means of the different physical characteristics of the different materials, the optic film realizes excellent optic performance. Also provided is a backlight module using the optic film.

### BACKGROUND OF THE INVENTION

(a) Technical Field of the Invention

The present invention relates to an optic film, and in particular to an optic film having a body formed by stacking multiple substrates to effect both diffusion and condensation of light and to be applicable to a backlight module.

(b) Description of the Prior Art

A thin-film transistor liquid crystal display (TFT-LCD) comprises a light source that is provided by a backlight module. The backlight module must provide light of excellent uniformity and brightness in order to ensure excellent subsequent applications and uses.

The backlight module uses various numbers of optic films, which include a diffusion film for diffusion of light and a prism film that condenses light. The number and arrangement of the optic films can be varied as desired.

The optic films, either the diffusion film or the prism film, have only a single function with respect to the light transmitting therethrough. Thus, a great number of optic films must be simultaneously used in order to achieve desired optic results. The optic films are often of high expenses and this makes the costs of the backlight module very high and also leads to troubles and problems associated with complicated inventory of parts.

A light condensation film is available in the market. As shown in FIG. 1 of the attached drawings, the known light condensation film, generally designated at 1, includes a substrate 11 and a plurality of prisms 12. The prisms 12 are lined up on a surface of the substrate 11. The substrate 11 further comprises a diffusion layer 13 arranged on the underside thereof. The diffusion layer 13 is formed by well stirring a resin 131 in which diffusion beads 132 are mixed. Since the diffusion layer 13 contains the diffusion beads 132 therein, when the diffusion layer 13 is coated on the underside of the substrate 11, the underside of the substrate 11 is provided with a diffusion layer 13 that diffuses light.

As shown in FIG. 2, when light passes through the diffusion layer 13 for emitting outwards, diffusion of the light occurs. Since the diffusion beads 132 are naturally formed light-transmitting spheres, they can, after condensing light, diffuse the light.

Such a structure of the conventional light condensation film 1 can realize both diffusion and condensation of light. Although the total number of optic films used can be reduced, yet the diffusion layer 13 of the light condensation film 1 must be separately coated on the underside of the substrate 11 after the resin 131 is mixed with the diffusion beads 132 and it cannot be used until the resin cures. Further, the diffusion beads 132 mixed in the resin 131 may be subject to non-uniform distribution through the resin. In addition, the diffusion beads 132 may also be subject to easy separation from the resin 131, leading to substantial deterioration of performance in diffusing light. Further, the prisms 12 are directly bonded to the surface of the substrate 11 by adhesives. In case that the adhesion capability of the substrate 11 is poor, secured bonding of the prisms 12 to the surface of the substrate 11 will be negatively affected, leading to poor performance of light emission of a backlight module incorporating the optic film.

In view of the above discussed drawbacks of the conventional light condensation film 1, the electro-optic industry is facing a challenge of developing an optic film that features both diffusion and condensation of light.

### SUMMARY OF THE INVENTION

The primary purpose of the present invention is to overcome the drawback of the conventional optic film that comprises a diffusion layer containing diffusion beads that are hard to uniformly distributed through resin making the diffusion layer and easy to separate from the resin and also comprises a substrate that may have poor bonding capability, leading to unsecured bonding of prisms to a surface of the substrate.

Thus, an objective of the present invention is to provide an optic film that comprises a body and a condensation layer. The body is formed by stacking a plurality of substrates made of different materials. At least one of the substrates has a surface forming a light incidence surface of the body and another substrate has a surface forming a light emission surface of the body. The light incidence surface is treated by knurling or sand blasting to form a roughened frosted surface. The substrate that forms the light emission surface of the body is made of a material having excellent bonding capability to facilitate bonding thereof to the condensation layer. The substrate that forms the light incidence surface of the body is made of a material that exhibits excellent light diffusion characteristics to enhance diffusion of light transmitting therethrough.

Another objective of the present invention is to provide an optic film that comprises a body and a condensation layer. The body is formed by stacking a plurality of substrates made of different materials. The surface of the substrate that forms the light incidence surface of the body and the surface of the substrate that forms the light emission surface of the body are both treated by knurling or sand blasting to form a roughened frosted surface. With the light emission surface being treated to form a roughened frosted surface, when the condensation layer is positioned on the light emission surface, the bonding force between the condensation layer and the substrate can be enhanced, and light is subjected to secondary diffusion by the frosted surface of the light emission surface before the light is condensed by the condensation layer and leaving the optic film.

A further objective of the present invention is to provide an optic film that comprises a body, which is formed by stacking a plurality of substrates of different materials, at least one substrate forming a light incidence surface of the body and another substrate forming a light emission surface of the body. The light incidence surface is treated by knurling or sand blasting to form a roughened frosted surface. The surface of the substrate that forms the light emission surface forms prism-like micro-structures thereon. When light enters the body through said another substrate that forms the light incidence surface, the light is diffused first and is then subjected to condensation by the micro-structures of the light emission surface, whereby the optic film realizes both diffusion and condensation of light.

Yet a further objective of the present invention is to provide an optic film that comprises a body, which is formed by stacking a plurality of substrates of different materials. The body comprises a substrate that forms a light emission surface and a substrate that forms a light incidence surface and further comprises at least one intermediate substrate interposed between the previous two substrates. The intermediate substrate is made of a material that exhibits excellent rigidity, or excellent ductility, or any desired particular optic characteristics, in order to enhance the performance of the optic film. Yet a further objective of the present invention is to provide a backlight module, in which the optic film described above is embodied. With the body of the optic film being formed by stacking a plurality of substrates of different materials and further with the substrate that forms the light incidence surface being subjected to knurling or sand blasting to form a roughened frosted surface and further with a condensation layer arranged on the substrate of the body that forms the light emission surface, when light enters the body through the light incidence surface, the light is diffused first and is then subjected to condensation by the condensation layer, whereby the optic film realizes both diffusion and condensation of light and the optic film exhibits excellent optic performance due to the different characteristics of the different materials.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is schematic view illustrating a conventional optic film;

FIG. 2 is a schematic view illustrating light transmitting through the conventional optic film;

FIG. 3 is a schematic view illustrating an optic film constructed in accordance with the present invention;

FIG. 4 is a schematic view illustrating light transmitting through the optic film of the present invention;

FIG. 5 is a schematic view illustrating an optic film constructed in accordance with another embodiment of the present invention;

FIG. 6 is a schematic view illustrating an optic film constructed in accordance with a further embodiment of the present invention;

FIG. 7 is a schematic view illustrating an optic film constructed in accordance with yet a further embodiment of the present invention;

FIG. 8 is a schematic view illustrating an optic film constructed in accordance with yet a further embodiment of the present invention;

FIG. 9 is a schematic view illustrating an application of the optic film of the present invention in a side-edge type backlight module; and

FIG. 10 is a schematic view illustrating an application of the optic film of the present invention in a direct type backlight module.

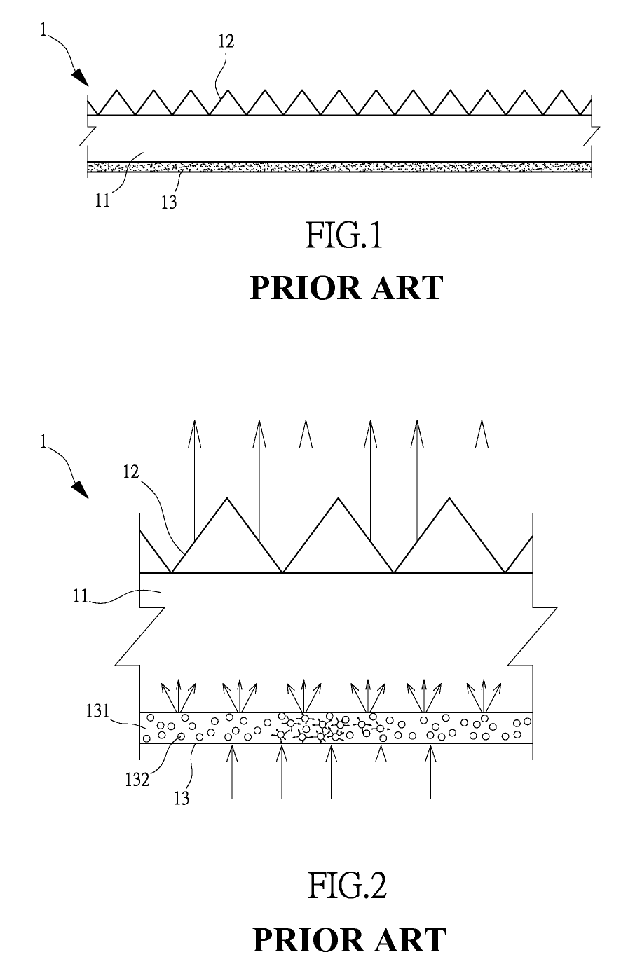

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

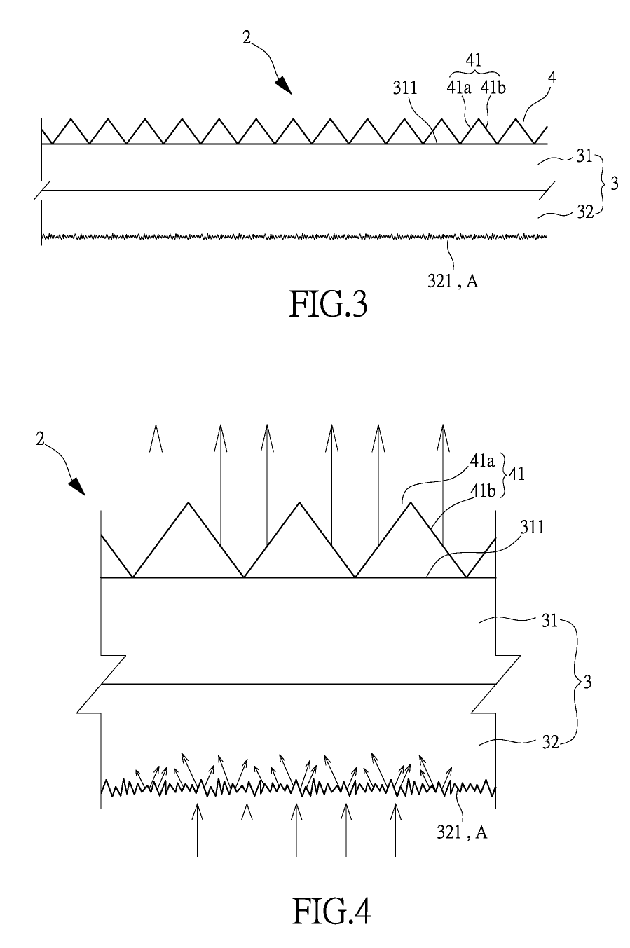

With reference to the drawings and in particular to FIG. 3, an optic film constructed in accordance with the present invention, generally designated with reference numeral 2, comprises a body 3 and a condensation layer 4. The body 3 is formed by stacking multiple layers of substrates 31, 32 that are made of different materials. In the embodiment illustrated, two layers of substrates are provided as an example for explanation. The substrates 31, 32 can be made of high-molecule materials or polymers, such as polycarbonate (PC), polyethylene terephthalate (PET) and polymethyl methacrylate (PMMA). At least one of the substrates, such as the substrate 32, has a surface serving as a light incidence surface 321 of the body 3; and one of the substrates, such as the substrate 31, has a surface serving as a light emission surface 311 of the body 3. The light incidence surface 321 is treated by means of knurling or sand blasting to form a roughened frosted surface A.

The condensation layer 4 is arranged on the light emission surface 321 of the body 3 and can be made of a material that is similar to or different from that of the substrate 21, such as PC, PET, and PMMA. The condensation layer 4 forms a plurality of prism-like micro-structures 41 and each micro-structure 41 includes a first planar surface 41a and a second planar surface 41b. The first surface 41a and the second surface 41b can cause internal reflection of light inside the prism to have the light condensed so that when the light emits outward through the micro-structure 41, condensation of the light can be resulted.

Referring now to FIG. 4, in an application of the optic film 2 in accordance with the present invention, the substrate 31 that forms the light emission surface 311 of the body 3 is made of a material that exhibits excellent bonding capability so as to facilitate bonding with the condensation layer 4, while the substrate 32 that forms the light incidence surface 321 of the body 3 is made of a material that exhibits excellent light diffusion characteristics to enhance diffusion of light transmitting therethrough. Thus, when light enters the body 3 of the optic film 2, the light passes through the light incidence surface 321 of the body 3 and is diffused by the roughened frosted surface A. Further, with the characteristics of the material that makes the substrate 32 that forms the light incidence surface 321, the diffusion of light can be enhanced. Thereafter, when light emits through the light emission surface 311 of the body 3, the light is subjected to condensation by the prism-like micro-structures 41 of the condensation layer 4 to thereby show enhanced brightness in leaving the optic film.

Further, when measurement is carried out under the condition that the light emission surface 311 of the substrate 31 of the body 3 in accordance with the present invention is made planar, the roughness of the frosted surface A of the light incidence surface 321 is preferably between 5-90%, whereby when detected under the condition that the condensation layer 4 is removed (by removing or filling flat the micro-structures 41 of the condensation layer 4), the body 3 of the present invention has light permeability of around 75-96%.

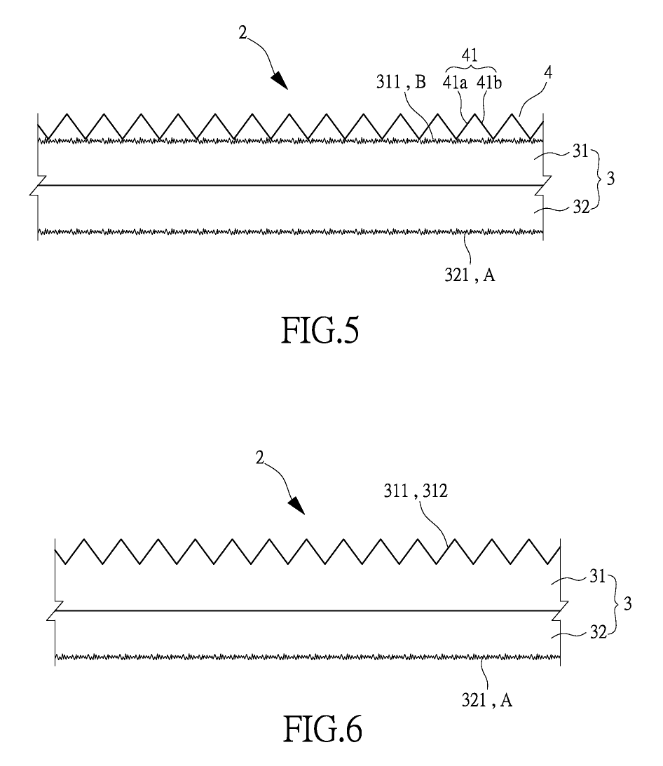

Referring to FIG. 5, to practice the optic film 2 of the present invention, the surface of the substrate 31 that serves as the light emission surface 311 of the body 3 can be treated by knurling, sand blasting or other treatments to form a roughened frosted surface B and the frosted surface B is further coated with a material similar to or different from that of the substrate 31, such as PC, PET, or PMMA, which layer of material is further processed to form the condensation layer 4 that comprises the plurality of prism-like micro-structures 41. By means of he roughened frosted surface B of the light emission surface 311, bonding force and bonding area between the condensation layer 4 and the substrate 31 is enhanced, which enhances the bonding capability between the condensation layer 4 and the substrate 31 and thus improves the bonding therebetween. Thus, when light is emitted, the frost surface B of the light emission surface 311 causes secondary diffusion of the light, which light is then condensed by the condensation layer 4 before eventually emitted outward.

Also referring to FIG. 6, in practicing the optic film 2 of the present invention, it is feasible to directly form prism-like micro-structures 312 on the surface of the substrate 31 that serves as the light emission surface 311 of the body 3. When light enters the substrate 32 through the light incidence surface 321, the light is first diffused by the frosted surface A of the light incidence surface 321 and is then condensed by the micro-structures 312 of the light emission surface 311. This similarly provides the optic film 2 with the effectiveness of both diffusion and condensation of light.

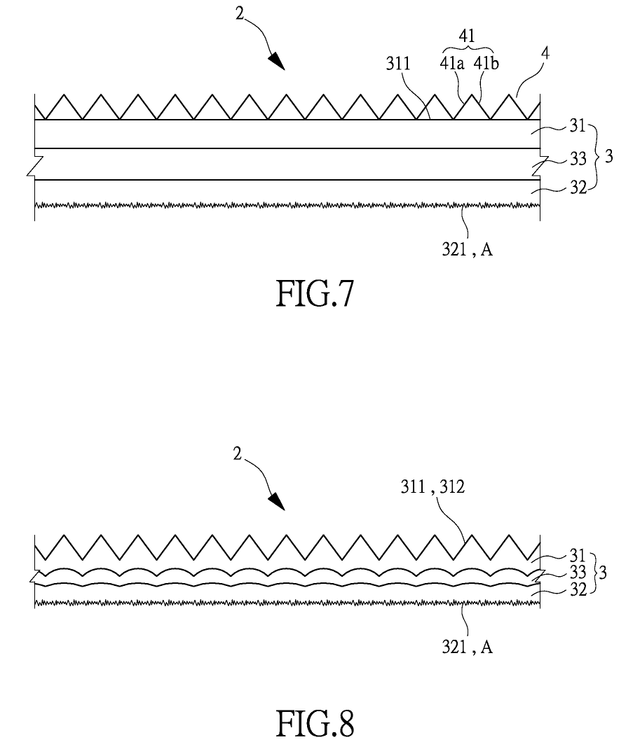

Referring to FIG. 7, besides the substrate 31 that provides the light emission surface 311 and the substrate 32 that serves as the light incidence surface 321, the body 3 of the optic film 2 in accordance with the present invention may further comprise one or more than one intermediate substrate 33 interposed therebetween. (In the embodiment illustrated, one intermediate substrate 33 is taken as an example for explanation, but it is noted that the present invention is not limited to such an example.) The intermediate substrate 33 can be made of a material that exhibits either excellent rigidity, or excellent ductility, or any desired particular optic characteristics, in order to enhance the performance of the optic film 2 of the present invention in any desired application. Further, besides taking the characteristics of material into consideration, the intermediate substrate 33 can be of various geometric configurations, such as that illustrated in FIG. 8, wherein the intermediate substrate 33 is made a continuously wavy configuration, or other desired configuration, so that when light passes through the intermediate substrate 33, the light can be affected by the intermediate layer 33 to provide enhanced effect of diffusion or condensation of light.

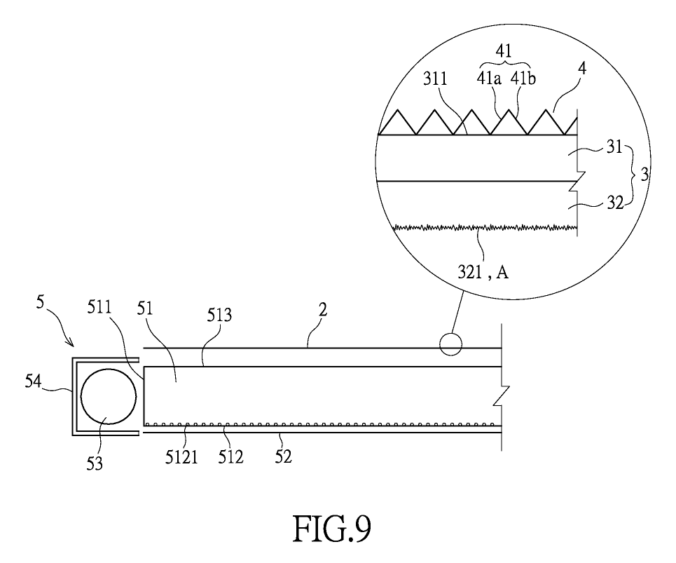

Referring to FIG. 9, which shows a schematic view illustrating an application of the optic film 2 of the present invention in a side-edge type backlight module 5, the side-edge type backlight module 5 comprises a light guide board 51, which has at least a light incidence surface 511, a reflection surface 512, and a light emission surface 513. The reflection surface 512 forms light guide patterns 5121. A reflector board 52 is arranged outside the reflection surface 512. Alight source 53 is arranged on one side of the light incidence surface 511. The light source 53 can be for example a cold cathode fluorescent lamp or a light-emitting diode, which is enclosed by a light reflector 54. The optic film 2 of the present invention is arranged on the light emission surface 513 of the light guide board 51 and the number of the optic film 2 used here can be a single film or more than one film, or alternatively, one or more than one diffusion films or condensation films can be further added above or under the optic film 2. With the roughened frosted surface A that is formed by knurling or sand blasting on the light incidence surface 321 of the body 3 of the optic film 2, and further with the condensation layer 4 that comprises prism-like micro-structures 41 arranged on the light emission surface 311 of the body 3, when the light from the light source 53 of the side-edge type backlight module 5 enters the light guide board 51 through the light incidence surface 511 of the light guide board 51 and then emits through the light emission surface 513 of the light guide board 51, and further enters the substrate 32 that forms the light incidence surface 321 of the optic film 2, the light is first diffused by the frosted surface A and is then subjected to condensation by the condensation layer 4. As such, the optic film 2 can provide both diffusion and condensation of the light, and by means of the characteristics of the different materials that make the substrates 31, 32, the uniformity and brightness of the light induced in the side-edge type backlight module 5 can be enhanced.

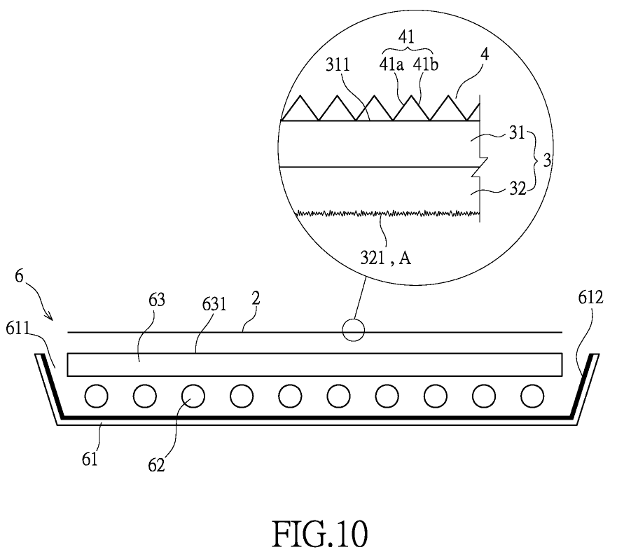

Referring to FIG. 10, which shows a schematic view illustrating an application of the optic film 2 of the present invention in a direct type backlight module 6, the direct type backlight module 6 comprises at least one case 61, a plurality of light sources 62, and a diffusion board 63. The case 61 forms, on a top thereof, an opening 611, which is convergent in a direction toward a bottom of the case 61. An internal surface of the case 61 is treated to form a shining surface or is provide with a reflection film 612 so that the case 61 can induce reflection of light therein. On the bottom inside the case 61, the light sources 62 are provided. The light sources 62 can be for example cold cathode fluorescent lamps or light-emitting diodes. The diffusion board 63 is arranged above the light sources 62 and covers the opening 611 of the case 61. The diffusion board 63 functions to make the light from the light sources 62 uniform and can be realized by containing therein diffusion agent or diffusion beads to effect diffusion of light. The diffusion board 63 has a top, light emission surface 631 outside which the optic film 2 of the present invention is arranged. The number of the optic film 2 used here can be a single film or more than one film, or alternatively, one or more than one diffusion films or condensation films can be further added above or under the optic film 2. With the roughened frosted surface A that is formed by knurling or sand blasting on the light incidence surface 321 of the substrate 32 of the optic film 2, and further with the condensation layer 4 that comprises prism-like micro-structures 41 arranged on the light emission surface 311 of the substrate 31, when the light from the light sources 62 of the direct type backlight module 6 enters the diffusion board 63 from below the diffusion board 63 and leaves the diffusion board 63 through the light emission surface 631, and further enters the substrate 32 through the light incidence surface 321, the light is first diffused by the frosted surface A and is then subjected to condensation by the condensation layer 4. As such, the optic film 2 can provide both diffusion and condensation of the light, and by means of the characteristics of the different materials that make the substrates 31, 32, the uniformity and brightness of the light induced in the direct type backlight module 6 can be enhanced.

The effectiveness of the present invention is that the body 3 of the optic film 2 is formed by stacking multiple substrates 31, 32 of different materials with at least one substrate 32 providing a light incidence surface 321 of the body 3 and a substrate 31 providing a light emission surface 311 of the body 3; the light incidence surface 321 is treated by knurling, sand blasting, or other treatments to form a frosted surface A; and a condensation layer 4 is arranged on a surface of the substrate 31 that forms the light emission surface 311, whereby by means of the different characteristics of the different material that make the substrates 31, 32, the optic film 2 can exhibit excellent optic performance.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An optic film comprising a body and a condensation layer, wherein the body is formed by stacking a plurality of substrates, of which at least a first one of the substrates has a surface forming a light incidence surface of the body and a second substrate has a surface forming a light emission surface of the body, the light incidence surface being roughened to form a frosted surface, the condensation layer being arranged on the light emission surface of the body and forming prism-like micro-structures.

2. The optic film as claimed in claim 1, wherein when measured under the condition that the light emission surface of the second substrate is planar, the light incidence surface of the first substrate exhibits a roughness between 5-90%.

3. The optic film as claimed in claim 1, wherein the body exhibits light permeability of 75-96% with the condensation layer removed.

4. The optic film as claimed in claim 1, wherein the substrates of the body are selectively made of a material identical to or different from the condensation layer.

5. The optic film as claimed in claim 1, wherein the substrates of the body are made of different materials.

6. The optic film as claimed in claim 1, wherein the surface of the substrate that forms the light emission surface of the body is roughened to form a frosted surface.

7. The optic film as claimed in claim 1, wherein the micro-structures are directly formed on the surface of the substrate that forms the light emission surface of the body.

8. The optic film as claimed in claim 1, wherein the body further comprises at least one intermediate substrate interposed between the substrate that forms the light emission surface of the body and the substrate that forms the light incidence surface of the body.

9. The optic film as claimed in claim 8, wherein the intermediate substrate is made of a material that exhibits excellent rigidity, or excellent ductility, or desired optic characteristics.

10. The optic film as claimed in claim 8, wherein the intermediate substrate is made a continuously wavy configuration or other desired configurations.

11. A side-edge type backlight module comprising:
a light guide board having at least a light incidence surface, a reflection surface, and a light emission surface;
a reflector board arranged outside the reflection surface of the light guide board;
a light source arranged by the light incidence surface of the light guide board;
a light reflector enclosing the light source; and
at least one optic film, and
wherein the optic film comprises at least a body and a condensation layer, the body having a light incidence surface and a light emission surface, the condensation layer arranged on the light emission surface of the body and forming prism-like micro-structures, the body being formed by stacking a plurality of substrates, the light incidence surface being roughened to form a frosted surface.

12. The side-edge type backlight module as claimed in claim 11, wherein when measured under the condition that the light emission surface formed on one of the substrates is planar, the light incidence surface formed on another one of the substrates exhibits a roughness between 5-90%.

13. The side-edge type backlight module as claimed in claim 11, wherein the body of the optic film exhibits light permeability of 75-96% with the condensation layer removed.

14. The side-edge type backlight module as claimed in claim 11, wherein the substrates of the body are selectively made of a material identical to or different from the condensation layer.

15. The side-edge type backlight module as claimed in claim 11, wherein the substrates of the body are made of different materials.

16. The side-edge type backlight module as claimed in claim 11, wherein the surface of the substrate that forms the light emission surface of the body of the optic film is roughened to form a frosted surface.

17. The side-edge type backlight module as claimed in claim 11, wherein the micro-structures are directly formed on the surface of the substrate that forms the light emission surface of the body of the optic film.

18. The side-edge type backlight module as claimed in claim 11, wherein the body of the optic film further comprises at least one intermediate substrate interposed between the substrate that forms the light emission surface of the body and the substrate that forms the light incidence surface of the body.

19. The side-edge type backlight module as claimed in claim 18, wherein the intermediate substrate is made of a material that exhibits excellent rigidity, or excellent ductility, or desired optic characteristics.

20. The side-edge type backlight module as claimed in claim 18, wherein the intermediate substrate is made a continuously wavy configuration or other desired configurations.

21. The side-edge type backlight module as claimed in claim 11, wherein the light source comprises a cold cathode fluorescent lamp.

22. The side-edge type backlight module as claimed in claim 11, wherein the light source comprises a light-emitting diode.

23. The side-edge type backlight module as claimed in claim 11 further comprising at least one diffusion film arranged outside the light emission surface of the light guide board.

24. The side-edge type backlight module as claimed in claim 23, wherein the diffusion film is arranged above or under the optic film.

25. The side-edge type backlight module as claimed in claim 11 further comprising at least one condensation film arranged outside the light emission surface of the light guide board.

26. The side-edge type backlight module as claimed in claim 25, wherein the condensation film is arranged above or under the optic film.

27. A direct type backlight module comprising:
a case, which forms an opening in a top thereof, the case having an internal surface that is made shinning or includes a reflection film attached thereto;
a plurality of light sources arranged on a bottom of the case;
a diffusion board arranged on the opening of the case above the light sources and having at least a light incidence surface and a light emission surface; and
at least one optic film, and
wherein the optic film comprises at least a body and a condensation layer, the body having a light incidence surface and a light emission surface, the condensation layer arranged on the light emission surface of the body and forming prism-like micro-structures, the body being formed by stacking a plurality of substrates, the light incidence surface being roughened to form a frosted surface.

28. The direct type backlight module as claimed in claim 27, wherein when measured under the condition that the light emission surface formed on one of the substrates is planar, the light incidence surface formed on another one of the substrates exhibits a roughness between 5-90%.

29. The direct type backlight module as claimed in claim 27, wherein the body of the optic film exhibits light permeability of 75-96% with the condensation layer removed.

30. The direct type backlight module as claimed in claim 27, wherein the substrates of the body are selectively made of a material identical to or different from the condensation layer.

31. The direct type backlight module as claimed in claim 27, wherein the substrates of the body are made of different materials.

32. The direct type backlight module as claimed in claim 27, wherein the surface of the substrate that forms the light emission surface of the body of the optic film is roughened to form a frosted surface.

33. The direct type backlight module as claimed in claim 27, wherein the micro-structures are directly formed on the surface of the substrate that forms the light emission surface of the body of the optic film.

34. The direct type backlight module as claimed in claim 27, wherein the body of the optic film further comprises at least one intermediate substrate interposed between the substrate that forms the light emission surface of the body and the substrate that forms the light incidence surface of the body.

35. The direct type backlight module as claimed in claim 34, wherein the intermediate substrate is made of a material that exhibits excellent rigidity, or excellent ductility, or desired optic characteristics.

36. The direct type backlight module as claimed in claim 34, wherein the intermediate substrate is made a continuously wavy configuration or other desired configurations.

37. The direct type backlight module as claimed in claim 27, wherein the light sources comprise cold cathode fluorescent lamps.

38. The direct type backlight module as claimed in claim 27, wherein the light sources comprise light-emitting diodes.

39. The direct type backlight module as claimed in claim 27 further comprising at least one diffusion film arranged outside the light emission surface of the light guide board.

40. The direct type backlight module as claimed in claim 39, wherein the diffusion film is arranged above or under the optic film.

41. The direct type backlight module as claimed in claim 27 further comprising at least one condensation film arranged outside the light emission surface of the light guide board.

42. The direct type backlight module as claimed in claim 41, wherein the condensation film is arranged above or under the optic film.
